(19) United States
(12) Patent Application Publication
(10) Pub. No.: US 2025/0146920 A1
(43) Pub. Date: May 8, 2025

(54) MEASUREMENT OF PARTICLE CONCENTRATION IN A STREAM

(71) Applicant: Canopus Drilling Solutions Holding B.V., 'S-Gravenhage (NL)

(72) Inventor: Jan Jette Blange, 'S-Gravenhage (NL)

(21) Appl. No.: 18/835,978

(22) PCT Filed: Feb. 1, 2023
(86) PCT No.: PCT/EP2023/052389

§ 371 Date: Aug. 5, 2024

(30) Foreign Application Priority Data
Feb. 4, 2022 (NL) 2030826

(51) Int. Cl. G01N 15/06; B03C 1/033; B03C 1/28; E21B 7/04; E21B 7/18

(52) U.S. Cl. CPC G01N 15/0656; B03C 1/0335; B03C 1/288; E21B 7/04; E21B 7/18; B03C 2201/18

(57) ABSTRACT

The invention relates to determining a concentration of magnetic particles in a stream of fluid mixed with the particles through an elongate circumferential enclosure at an axial measurement location along the stream. Use is made of a coil with multiple electrically conducting windings arranged to each tangentially surround the stream at the axial measurement location, for generating a magnetizing field which extends with a radially inwards part thereof inside the stream and with a radially outwards part thereof outside the stream, and of a sensor configured for producing a signal indicative of a magnetic flux density caused by the magnetizing field generated around the coil and/or a change therein. An electromagnetic permeability in the magnetizing field is increased in in the radially inwards part of the magnetizing field by a particle directing tool directing the particles in the stream radially outwardly towards an inner circumference of the coil, and/or in the radially outwards portion of the magnetizing field, by magnetically conducting elements extending along a path around the coil windings so as to guide field lines of the magnetizing field therethrough.

The invention relates to a device and method for measuring a concentration of magnetic particles within a stream of fluid mixed with these particles.

In particular in applications employing abrasive particles within a stream of fluid for abrasive blasting or cutting or drilling by means of, or assisted by, an abrasive jet, the control of such blasting, cutting or drilling is commonly based on real-time measurement of particle concentration along at least a supply stream with the particles that is to form the abrasive jet after passing the jet nozzles. Particle concentration measurements are preferably performed at multiple locations along the stream, so that a comparison between the measured values is possible. Such comparison may for example yield real-time indications of the velocity and flow rate of the particles in the stream—e.g. as determined from a distance between the measurement locations and a time period between a measured passing of a particle concentration fluctuation. The so-determined velocity and/or flow rate may e.g. be used in feedback control of the erosive power of the abrasive jet. The measurements may also yield real-time indications of particle concentration along the stream at a certain time instant and as a function of time at the measurement locations, but also at other locations e.g. based on a distance thereof from the measurement locations.

The measured velocity and/or may also be used to determine a time instant at which, or a time period after which, certain portions of particles within the stream will arrive at the jet nozzle, for example time instants at which subsequent portions of the stream having alternatingly high and low particle concentrations will arrive at the jet nozzle. For example in a known method for directional drilling, e.g. as disclosed in WO2021069694, subsequent portions of the stream with alternatingly high and low particle concentrations are selectively passed through the nozzle, and thereby brought into impingement with a borehole bottom, at different azimuthal sections, in order to obtain a difference between these sections in the extent of erosion of the borehole bottom material. Consistently directing the portions with a low concentration in a first azimuthal section, and portions with a high concentration in a second section, for a sustained period of time, creates a bent borehole section. To achieve this, a jet nozzle is rotated to be periodically alternatingly directed towards each section. In this rotation the nozzle, and therewith, the stream with the particles, is to be directed at the first azimuthal section when a portion with a low concentration passes the nozzle, and at the second azimuthal section when a portion with a high concentration passes. The velocity and/or flow rate measurements may be used in controlling the rotational movement of the nozzle to achieve the desired azimuthal positions thereof at the specific time instants of passing a certain stream portion. Furthermore, the creation of the low and high concentration stream portions by an actuator provided for this purpose, may be controlled—e.g. including adjusting the volumes of the stream portions, concentrations thereof and/or differences there between. The concentration and/or flow rate of the supply stream may also be controlled based on the measurements.

It is known to apply magnetic abrasive particles in directional drilling applications. The magnetic property may therein for example be employed to direct particles in the stream towards the nozzle, to capture particles after impingement in a return stream through the annulus towards the surface at a downhole location for local recirculation into the stream towards the nozzles, and to create alternating low- and high concentration stream portions.

It is also known to perform presence detection of magnetic particles based on the magnetic property thereof. For this purpose, sensors are applied in the particular form of inductive magnetic sensors or magnetometers. The inductive magnetic sensors are known in the art e.g. for measuring the static level of magnetic particles in a container, e.g. a tube, alike in US2010243240, by measuring the self-inductance in a coil of the sensor. The self-inductance of the coil varies with the number of magnetic abrasive particles present inside the coil, and is determined by the ratio of the voltage and the rate of change of the current in time. When a varying AC current is ran through the coil, the self-inductance can be determined by an accurate voltage and current measurement during the process. Alternatively, the magnetic field induced by the coil, which increases with the number of particles inside the coil, may be measured to determine the number of particles. Therein for example a Hall probe may be arranged at or near the sensor location, which is known in the art for example from its use in linear displacement sensors (LVDT's) and linear motors. In case of a magnetic field measurement e.g. by a Hall probe, a correction for the magnetic field of the earth may be provided in processing and interpreting the measurements.

Prior art methods for measuring magnetic particle concentration along a stream are not satisfactory in terms of energy consumption by the sensors, dependence on the type of fluid with which the particles are mixed, and accuracy. In drilling applications, the latter may be negatively influenced, for example, by environmental disturbances such as the magnetic field of the earth, surrounding magnetically active material, and equipment, e.g. including electromotors.

In drilling applications, in particular directional drilling, a high energy consumption is undesirable as this requires a downhole power supply, e.g. in the form of batteries or a downhole power generator. This is an awkward complication of any system given the harsh downhole environment. A low accuracy in general is undesirable as it may negatively affect the reliability and consistency of the measurements—and therefore the control of the jet nozzle rotation and of erosive power. A dependence of the measure on the type of fluid may furthermore affect the consistency of measurements and reliability over different applications.

The present invention aims to provide a device and method which, at least partly, addresses these issues.

The present invention provides a device according to claim 1.

The device is suitable for measuring a concentration of magnetic particles in a stream of fluid mixed with the magnetic particles through an elongate circumferential enclosure at an axial measurement location along the stream. The magnetic particles of which the concentration is to be measured may be abrasive particles, e.g. for use in an abrasive jet drilling system. The fluid may be a liquid, e.g. a drilling liquid in drilling applications. The magnetic particles may be ferromagnetic, e.g. a steel shot, as is common in abrasive jet drilling. The elongate circumferential enclosure is for example a tube, e.g. having a circular cross-section.

The circumferential enclosure, and therewith, the stream, has an axial center axis. Corresponding to the convention, in the context of the invention the axial direction is in the flow direction of the stream, and the radial directions run outwardly from and perpendicular to the axial center axis. In case of a tubular flow through a tube, the axial center axis has a constant radial distance to an inner circumference of the tube—and thus an outer circumference of the stream along the angular range around the center axis.

The device comprises a coil with multiple electrically conducting windings arranged to each tangentially surround the stream at the axial measurement location. Thus each winding surrounds the stream in the tangential direction over the angular range of the axial center axis. The coil is therewith arranged to generate, when an electrical current flows through the coil, a magnetic field which extends with a radially inwards part inside the stream, and with a radially outwards part outside the stream. In the radially inwards part of the magnetizing field, the field lines extend through the coil. In the radially outwards part of the magnetizing field, the field lines extend around the coil. The intensity of the magnetizing field is according to the convention denoted by ‘H’. The coil has connection points for electrical connection to an external electrical current source. As is known, the current flow causes a magnetizing field to be established around the axial extension of the coil, with field lines in the radial-axial planes perpendicular to the windings. The field lines run in the axial direction radially inside the coil, bending radially outwards around an axial end of the coil to the reverse axial direction outside of the coil, and bending radially inwards again around the opposite axial end of the coil to the inside of the coil. Thus, magnetic field lines in the radially inwards part of the magnetizing field run at least partly axially, parallel to the flow direction of the stream, and thus, the particles. It is envisaged that the coil is arranged concentric to the stream, with an axial center axis coinciding with the axial center axis of the stream and circumferential enclosure. The coil is preferably adapted to surround the circumferential enclosure, e.g. concentric to the stream, e.g. the windings of the coil having an inner circumference adapted, e.g. corresponding, to an outer circumference of the circumferential enclosure.

The device further comprises a sensor which is configured for producing a signal indicative of a density (conventionally denoted by ‘B’) of the magnetic flux caused by the magnetizing field (H), and/or a change in such magnetic flux density (B). From the indication of the magnetic flux density (B), an indication of the number of particles present inside the coil can be determined—and therewith, of the particle concentration. The sensor has connection points for connection to an external control unit. Such control unit may be applied e.g. to register and/or interpret the measurements, e.g. in order to use the measurements for example in monitoring or control of external components.

According to the invention, the device further comprises a permeability promotor, which is suitable for increasing an electromagnetic permeability (conventionally denoted by ‘μ’) in the magnetizing field (H). As is known in the art, the induced magnetic flux density (B) scales with the permeability (μ)—as at any location or in time the two fields H and B are proportional by μ through

$$B = μ \cdot H .$$

Increasing the permeability (μ) at a certain location in the magnetizing field (H) thus increases the absolute value of the magnetic flux density (B) induced by the magnetizing field (H), which represents the amount of particles of the stream that is present inside the radially inwards part of the magnetic field. With an increased permeability (μ), the same flux density can be achieved with a lower field strength of the magnetizing field (H)—which may advantageously reduce the required current for generating it—and thus, reduce the energy consumption, and/or decrease a required size, e.g. length, of the coil. A shorter length, i.e. axial extension, of the coil may advantageously higher accuracy of a control based on the measurements, as the axial position of the passing particles at the time of the measurement thereof is more accurately known.

The increased permeability (μ) furthermore enables that the sensitivity of the magnetic flux density (B) to the value of interest, i.e. the amount of particles passing the measurement location, to the signal indicating the magnetic flux density may be enhanced, as will be explained below, and therewith, that the accuracy of the measurement may be improved.

In the radially inwards and outwards part of the magnetic field, the permeability is according to the invention, increased in different respective ways. This is because in the radially inwards part, the particles, of which the amount forms the value of interest, are present and the objective for the measurement is based on the sensitivity of the measured value for the amount of particles. To optimize this sensitivity, in the radially inwards part, an increased permeability should emanate as much as possible from the presence of the particles itself, and as less as possible from other influences, such as the type of fluid, or objects. Furthermore, any measures for increasing the sensitivity should not disturb the particle flow, including the concentration or any intended variations therein, itself. In the radially outwards part, however, the particles forming the subject of the measurement, are not present. Therefore, the permeability in this radially outwards part does not involve the particles, and therefore, an increase thereof desensitizes the measurement for changes in the permeability due to other influences-which may in turn enhance the sensitivity to the permeability that is caused by, the particles in the radially inwards part. Thus, the sensitivity to the amount of particles in the radially inwards part of the field increases with a higher permeability in the radially outwards part. Furthermore, any physical objects provided as measures to increase permeability, are in this part of the magnetizing field not in physical contact with the stream and the particles to interfere with the flow.

Based on these insights combined, the permeability promotor comprises according to the invention measures to increase the permeability as specifically caused by the particles in the radially inwards part of the magnetizing field, measures to increase the permeability as not caused by the particles in the radially outwards part of the magnetizing field, or both.

In particular, the promotor comprises as these measures, respectively, a particle directing tool for directing the particles in the stream in a radially outwards direction with respect to a center axis, towards an inner circumference of the coil, one or more magnetically conducting elements in the radially outwards part of the magnetizing field (H), or both.

The first measure, the provision of the particle directing tool, causes the particles to be displaced radially outwardly. This firstly increases the particle concentration in a radially outward portion of the stream, since the distribution of the particles over a cross-section of the stream is changed to an increased amount of the particles in the radially outward portion of the stream and a decreased amount in a radially inwards portion of the stream. This increases the permeability (μ) in the radially outward portion of the stream as the amount of magnetic material is higher, and concentrates the field lines to the particles in the outward portion. The radially outwards displacement secondly causes the particles to be arranged closer to the coil windings, where the magnetic flux density (B) is naturally higher-given that the magnetic flux density decreases with distance to the current flow. Both effects combined, advantageously have the result that the increased permeability (μ) due to the higher concentration of particles causes a larger change in the magnetic flux density (B) caused by the magnetizing field (H). Thus, the particle directing tool may enhance the sensitivity of the measurement in two mutually reinforcing ways.

Moreover, the first measure may decrease the dependence of the signal to the type of fluid in the stream, and therewith, the accuracy and consistency of the measurement, since the influence of the particles is increased over any influence of the fluid thereon.

The second measure, the provision of the one or more magnetically conducting elements in the radially outwards part of the magnetizing field (H), causes the permeability (μ) to be increased in the radially outward portion of the magnetizing field (H) as mentioned. Simultaneously, the conducting element(s) advantageously concentrate the field lines of the magnetic field (H), such that these extend through the conducting element(s). Where a sensor is provided that comprises a magnetometer in the magnetic field, the conducting element(s) may be shaped and arranged relative to the magnetometer such that the field lines are guided therethrough towards the magnetometer, to further improve the measurement thereby.

Thus, by the first and second measure, the accuracy and signal-to-noise ratio of the sensor signal may advantageously be enhanced, through the enhanced sensitivity of the signal for the amount of particles. Secondly, the amount of energy and/or coil size required to generate a magnetizing field (H) causing the same flux density (B) may advantageously be decreased—as the required strength of the magnetizing field (H) is lower.

### Particle Directing Tool

In an embodiment the particle directing tool, if present, of the permeability promotor is configured for being arranged inside the circumferential enclosure. This enables to manipulate the stream by a physical interaction therewith, for example by creating a thrust in the stream which creates a local radially outwardly directed current. This thrust may for example be created by movement of physical parts in the stream relative to the circumferential enclosure, or for example by pumping.

Other embodiments are possible e.g. in the form of magnetic elements bending off the particles radially outwardly, however these are less preferred for their possible interference with the measurements. If applied, these can e.g. be placed at a sufficient distance upstream from the measurement location, therein relying on the relatively high inertia of the particles relative to the fluid of the stream, so that these are able to continue to move forward in the radially outwards portion of the stream relatively long.

In embodiments, the particle directing tool is provided at the axial measurement location, and/or at some distance upstream of the measurement location, e.g. to facilitate an axial component of the movement of the particles towards the coil inner circumference. In an embodiment the particle directing tool is provided upstream of the measurement location at an axial distance of 0 to 20 times an inner diameter of the circumferential enclosure from the measurement location, e.g. at a distance of around 1, 2, 3, 4, 5, 6, 7, 8, 9 or 10 times the inner diameter. Other distances are possible-however should be such that the particles still have displaced sufficiently radially outwardly when passing the measurement location to have the effect of the increased permeability (μ) in the radially inwards part of the magnetizing field (H) generated by the coil.

It is noted that in the context of this disclosure, the term ‘diameter’ is intended to refer to an effective diameter where a cross-section is not circular. The same applies to the term ‘radius’, which should in case of non-circular cross-sections be taken to mean the ‘effective radius’ thereof. For example, the circumferential enclosure may be embodied as a tube, as is preferred, however channels with a square, rectangular polygonal or oval cross-section are also possible.

Preferably the particle directing tool is configured to direct the particles in the stream to as close as possible to the inner circumference of the coil windings-thus, as close as possible to the outer circumference of the stream, in order to increase the permeability (μ) as much as possible.

In an example the particle directing tool is configured to direct the majority of the particles into a radially outwards portion of the stream that covers the outer 50% of a radius of the circumferential enclosure, with respect to the central axis, when the particles pass the measurement location. It is however preferred that the particle directing tool is configured so that the outwards portion of the stream into which the majority of the particles is directed is however smaller, for example covering 45%, 40%, 35%, 30% or less of the radius. Preferably the particle directing tool is configured to direct substantially all, e.g. all, particles into the radially outwards portion covering 50%, 45%, 40%, 35%, 30% or less of the radius.

Preferably the particle directing tool is configured for being arranged inside the circumferential enclosure and comprises one or more directing elements configured for directing the particles within the stream radially outwardly, and a mounting element for connection of the directing element to the circumferential enclosure. In an embodiment the particle directing tool is a whirler, configured to generate in the stream a whirl in a radially central portion of the circumferential enclosure, e.g. a whirl around the center axis. Therein the connection of the directing elements of the particle directing tool to the circumferential enclosure via the mounting element is such that the directing elements are rotational around an axial rotation axis, e.g. the rotation axis coinciding with the axial center axis of the circumferential enclosure. The one or more directing elements are for example one or more ribs, e.g. three ribs, each helically shaped around the axial rotation axis of the whirler, e.g. identical ribs, e.g. each having a corresponding axial extension in the stream, e.g. the ribs being angularly evenly distributed around the rotation axis. The rotating flow of the whirl hurls the particles in the stream radially outwardly towards the outer circumference of the stream—to thus be collected and concentrated in a radially outward portion of the stream. In practice, a whirl as generated by the whirler will be maintained for a certain distance, for example 10-30 times, e.g. around 20 times, a stream diameter, so that the particles will remain in the outward portion over a limited distance. The measurement location should, naturally, be within that distance. Preferably the whirler is placed upstream of the measurement location, e.g. as mentioned before, at an axial distance of 0 to 20 times the inner diameter of the circumferential enclosure.

### Magnetically Conducting Element(s)

In an embodiment, the one or more magnetically conducting elements, if present, of the permeability promotor tangentially extend along the majority of, e.g. the entire or substantially the entire, coil circumference, i.e. over the majority of, e.g. the entire or substantially the entire, angular range with respect to the axial center axis. A larger tangential extension of the conducting element(s) is preferred as it enables magnetic conduction to take place, and thus the permeability to be increased (μ)—over a larger part of the angular range of the magnetizing field.

In an embodiment, one or more of the magnetically conducting elements are arranged and sized to extend at a distance from the coil of around half a diameter of the coil, or smaller. A smaller distance leads to a larger increase in the permeability (μ) and is therefore preferred. For example a distance of around 40%, 30%, 20%, 10% or 5% of the coil. For the same reason, a larger extension of the conducting element(s) along the magnetic field lines is preferred. For example, for elements provided for conducting in the axial direction, an axial extension in an axial-tangential plane of 50-150% of a length of the coil, and for conducting in the radial direction, a radial extension of 10-50% of the diameter of the coil. Furthermore, a larger extension in the tangential direction is preferred.

In an embodiment, one or more of the conducting elements are ferromagnetic. Depending on the material of the magnetically conducting element(s), the permeability may be increased, over the extension of the element, to the range of magnitude of 10⁻⁴-10⁰ H/m. For example, ferritic steel yields a permeability in the range of 10⁻³ H/m. Other example materials are metglas, other types of steel, ferrites, iron or known iron-alloys such as Cobalt-iron, permalloy, and mu-metal. In practice, such elements can be regarded to essentially short-circuit the magnetizing field over their extension.

In an embodiment the one or more magnetically conducting elements include one or more elements which are configured to conduct in at least the axial direction, e.g. these elements extending in tangential-axial planes. In an embodiment the magnetically conducting element(s) include one or more elements which are configured to conduct in at least a radial direction, e.g. these one or more elements extending in tangential-radial planes. Elements combining radial and axial conduction are also envisaged, for example having both one or more tangential-axial planes and one or more tangential-radial planes.

### Sleeve

In an embodiment the one or more magnetically conducting elements of the permeability promotor comprise a magnetically conducting sleeve, configured to tangentially surround the coil at least between axial ends thereof, e.g. only between these axial ends, or both between and beyond one or both these axial ends, for axially conducting the generated magnetizing field (H) at least therebetween, wherein the sleeve axially extends along a major part of, e.g. the entire, coil. The sleeve establishes axial magnetic conduction radially outwards from the coil windings, in order to reduce influences of other disturbing magnetic fields on the measurement by the sensor. The sleeve is preferably cylindrically shaped and preferably extends concentric to the coil—this enables the sleeve to advantageously follow substantially corresponding field lines of the magnetizing field over the entire tangential extension of the sleeve so as to substantially uniformly increase the permeability (μ).

In an embodiment, the sleeve is configured to mate with the circumferential enclosure axially from the coil-thus at an axial distance from an axially outermost winding. For example an inner circumference of the sleeve corresponds to an outer circumference of the circumferential enclosure. In an embodiment, the coil is adapted to surround the circumferential enclosure, and has between the axial ends thereof an inner circumference which is radially spaced from the coil. The sleeve extends at one or both of the axial ends thereof axially beyond the coil, and furthermore has at these one or both of the axial ends a radially inwards flange adapted to mate with the circumferential enclosure. For example an inner edge of the flange is complementary to an outer circumference of the circumferential enclosure. Thus in this embodiment, the sleeve covers the coil both radially and axially outwardly. This embodiment enables both axial and radial conduction-respectively between the axial ends, and by the radially inwards flange.

In an embodiment the sleeve has a gap which axially extends through the sleeve thereby separating two tangential ends of the sleeve and interrupting any tangentially directed electrical currents through the sleeve. Such tangentially directed electrical currents may in particular in applications where an alternating current is ran through the coil, and the magnetizing field has opposed directions with the alternation of the current, unduly disturb the changes in the magnetizing field caused by the alternation. The gap interrupting tangentially directed currents may resolve the disturbance thereby, and facilitate the changing of the magnetizing field.

### Sensor

In embodiments the sensor determines the magnetic flux (B) from current and voltage measurements on the coil, by determining the self-induction of the coil as is known in the art.

In preferred embodiments however, a magnetic sensor is provided for measuring the magnetic flux (B) directly by a physical interface with the magnetic field—i.e. a sensor not electrically connected to the coil. In embodiments the magnetic sensor comprises a magnetometer which is arranged inside the magnetizing field generated through and around the coil. In an example the magnetometer is arranged at or near an axial end of the coil, e.g. directly axially upstream or downstream of the coil, when considering the flow direction of the stream. Where the device comprises a sleeve, the magnetometer may be arranged axially directly adjacent the sleeve, or e.g. axially within the contour of the sleeve radially inwardly therefrom.

The magnetometer is preferably triaxial-however, alternatively it may be diaxial or monoaxial. Particularly in case of a monoaxial sensor, the axis thereof is therein preferably oriented in a direction of the a relatively high, e.g. the highest, expected flux density within the magnetic field (H) to optimize the signal. The magnetometer may be a solid state Hall effect sensor, although other types are suitable as well.

In an embodiment comprising the sleeve, the sensor, in particular the magnetometer thereof, may be arranged at or near an axial end of the coil, the sleeve therein comprising an axial lip which projects from the sleeve such as to radially align with the magnetometer. Thus, the magnetometer is arranged relative to the sleeve so as to extend within the contour of the axial lip. The magnetometer is preferably arranged radially inwardly from the axial lip, i.e. closer to the axial center axis, so that the axial lip may furthermore serve as a protective cover for the magnetometer.

In an embodiment wherein a magnetometer is provided, the one or more magnetically conducting elements of the permeability promotor preferably comprise a magnetically conducting intermediate member. This intermediate member is arranged to extend within the generated magnetizing field (H) at least partly between the magnetometer and the stream, for conducting the generated magnetizing field between the stream and the magnetometer. The conducting member may be cylindrically shaped and/or configured to, viewed in the axial direction, extend concentric to the coil-which may be practical for its arrangement in or around the circumferential enclosure. In an embodiment, the intermediate member is configured to surround the stream—in order to facilitate collection of magnetic field lines along the entire or substantially the entire angular range with respect to the center axis. The intermediate member may surround the circumferential enclosure, or may surround the stream by extending radially in between axially overlapping wall portions of the circumferential enclosure. In an example the intermediate member is adapted to mate with the circumferential enclosure, e.g. an inner or outer circumference of the intermediate member corresponding to respectively an outer or inner circumference of the circumferential enclosure or a part thereof. In an example, the conducting member may be arranged inside a wall of the circumferential enclosure to avoid direct contact with the stream, for example to be arranged radially between axially overlapping wall portions thereof, for example embedded at the outer circumference of a radially inwards wall portion and/or at the inner circumference of a radially outwards wall portion.

In an embodiment, the intermediate member has a gap which axially extends through the intermediate member thereby separating two tangential ends of the intermediate member and interrupting any tangentially directed electrical currents through the intermediate member. Alike the optional gap in the sleeve if present, the gap in the intermediate member interrupting tangentially directed currents may resolve disturbance thereby, and, particularly in case of alternating current through the coil, facilitate the involved changing of the magnetizing field.

In an embodiment wherein the sleeve with the axial lip is provided at or near an axial end of the coil, the magnetometer preferably extends between the axial lip of the sleeve and the intermediate member. Therein the magnetometer, the axial lip, and the intermediate member are preferably radially aligned with one another. In this way the magnetometer is essentially sandwiched by the magnetically conducting axial lip and the intermediate member, to advantageously further enhance the permeability in the vicinity of the magnetometer where the magnetic flux density (B) is actually measured. In an example, along an angular range of the intermediate member outside the angular range of the axial lip of the sleeve, a shortest distance between the sleeve and the intermediate member is larger than a shortest distance between the axial lip and the intermediate member within the angular range of the axial lip of the sleeve, for example 50% to 150% larger. The purpose of this measure is to urge the magnetic field lines in the radially outwards portion of the magnetic field (H) that extend outside the angular range of the axial lip to run to the axial lip of the sleeve through the sleeve itself, having a tangential component, and subsequently, within this angular range, through the magnetometer from the axial lip to the intermediate member—and to decrease the tendency for these magnetic field lines to run tangentially towards the axial lip through the intermediate member so as to unduly bypass the magnetometer. Such may e.g. be achieved by a tapering of the sleeve at the axial end of the sleeve where the lip is provided, so that an axially outer edge of the sleeve extends, viewed in a diametrical-axial plane through the axial lip, from the lip to the diametrically opposite side of the sleeve slanting in the axial direction away from the lip-thus at an angle with the radial direction through the lip.

In an embodiment the device further comprises a sensor housing, configured to with an axial end thereof axially abut the sleeve. The sensor housing has at the abutting axial end an axial recess, which is configured to receive the axial lip. The housing is configured to accommodate the sensor with the magnetometer extending inside the recess—even as the axial lip, so as to establish the radial alignment with the axial lip—with the magnetometer extending radially inwards of the axial lip. Therewith, the sensor housing provides, together with the axial lip, a protective cover for the sensor, as facilitated by the recess for receiving the axial lip. At the same time the axial lip is enabled to provide its advantages for the permeability enhancement in the vicinity of the magnetometer.

### Assembly and Control

The invention furthermore relates to an assembly according to claim 22. Suitable embodiments are defined in claims 23-25. The assembly comprises one or more devices according to the invention and the elongate circumferential enclosure as referred to herein, for accommodating the stream therethrough. Therein the circumferential enclosure is made out of a magnetically and electrically non-conducting material, so as to facilitate that in the radially inwards part of the magnetizing field (H), the particles have the largest possible contribution to the magnetic permeability.

The invention furthermore relates to an assembly according to claim 26. The assembly comprises one or more devices, or the previously described the assembly according to the invention, and an electrical power source. The electrical power source is connectable or connected to the coil of each device via the connection points thereof for providing the electrical current through the coil. The current results in the magnetizing field (H).

In an embodiment the electrical power source is configured to provide the electrical current through the coil of the device as an alternating current (AC). The alternating current causes the magnetizing field to periodically have opposed directions with the alternation of the current, but equal magnitudes. A disturbing magnetic field, e.g. the earth magnetic field, which is static and does not exhibit any, or the same, periodic variation imposed by the alternating current, will not add to the measured magnetic flux density such as to follow the periodic variation of the magnetizing field (H) generated by the coil. It will cause an asymmetry in the signal, i.e. an absolute difference when comparing the absolute values of the measured flux density (B) with both opposed directions. This enables to determine its contribution to the signal from the course of the indicated value with time—as this difference between the absolute measured values indicates the disturbing flux density. This in turn advantageously enables to determine an indication of the magnetic flux density with an enhanced signal-to-noise ratio, wherein the disturbing flux density has been cancelled, i.e. filtered out—for example, by means of a control unit connected to the sensor and programmed to do so. It is noted, that a noise part of the signal may also be determined from a current variation other than an alternating current. However, an AC current is preferred as it generates the magnetizing field with equal magnitudes at the opposite directions-so that throughout the measurement the same particle amounts can be correlated with the same flux densities.

The invention furthermore relates to an assembly according to claim 28. This assembly comprises a control unit connectable or connected to the sensor of each device via the connection points thereof for communication of the signal produced by the sensor to the control unit. The control unit is programmed to determine from the signal that is produced by the sensor and communicated to the control unit, and is indicative of the magnetic flux density (B), an amount of the magnetic particles within the stream passing the axial measurement location. This determined amount may for example be in the form of a determined concentration of the particles in the stream, and/or a rate of change therein.

In case of multiple devices, of which the axial measurement locations are at an axial distance from one another, a velocity may be determined by a comparison of the measurements by each of these devices. In an embodiment the control unit is furthermore programmed to determine a velocity of the particles passing the axial measurement locations, based on the axial distance between the respective measurement locations of the devices, and a time period between the passing of these measurement locations by the particles. For example, the control unit is programmed to determine a flow rate of the particles in the stream, which determination is furthermore based on the determined amount of the particles, e.g. the concentration thereof in the stream. This enables a particular embodiment wherein the control unit is furthermore programmed to predict a timing at which the passed particles will arrive at an axial location downstream of the measurement locations, based on the determined amount and velocity of the particles and an axial distance from the measurement locations to the downstream location. This embodiment may provide particular advantages during use in a drilling system wherein the particles are abrasive particles, and the downstream location is the location of one or more abrasive jet nozzles configured for ejecting the stream in the form of an abrasive jet into impingement with a borehole bottom—as the timing of arrival at the abrasive jet nozzles may be a relevant parameter in the control of the erosion of the borehole bottom. In an embodiment, the assembly is suitable for use in a directional drilling system. The jet nozzles of such directional drilling system are configured for ejecting the stream into impingement with a borehole bottom at different azimuthal positions, as controlled by the control unit. In this embodiment the control unit is thereto furthermore programmed to in dependence of the determined amount of the particles passing the measurement location, at the predicted timing of their arrival at the jet nozzles, selectively cause ejection of the particles at one of the azimuthal positions. For example in case of one rotating jet nozzle, the rotation of this jet nozzle may be controlled by the control unit to selectively eject the particles at the azimuthal position associated with these particles at their time of passing the nozzle. Or for example in case of multiple jet nozzles each having stationary azimuthal position, the selective directing of the particles into each nozzle having the azimuthal position associated therewith at the time of passing the nozzle by a connected controllable directing tool in the drill bit may be controlled by the control unit. For example, in case of alternating high- and low concentration stream portions, the control unit may selectively eject for a sustained period the low concentration stream portions at a first azimuthal position of the borehole bottom to cause less erosion there, and the high concentration stream portions at a second azimuthal position to cause more erosion there, so as to create a bend in the borehole towards the first azimuthal position.

In an embodiment suitable for use in a directional drilling system, the control unit is furthermore connected to an actuator of the directional drilling system for producing, in the stream be supplied to the jet nozzles, stream portions with varying, e.g. alternatingly high and low, concentrations of particles, and is furthermore programmed to in dependence of the determined amount of the particles passing the measurement location and/or a determined velocity of the particles and/or a predicted timing of arrival of the particles at the jet nozzles, control the actuator such as to adjust one or more properties of these stream portions, e.g. concentrations and/or volumes thereof, and/or timings and durations of a production of, these stream portions. An actuator for producing stream portions with varying particle concentrations is disclosed in WO2021069694.

Positional and navigational sensors of the directional drilling system may be used for obtaining feedback on the direction and rotational position of the drill-bit, inclination, azimuth, and toolface with respect to the local earth magnetic field and the gravitational vector g. This feedback may be used in addition to the sensor signals to control the actuator, adjusting thereby the drilling direction where necessary. The actuator might be located at a distance of multiple metres from the drill bit. But the surveying and/or directional sensors are preferably located close to the drill bit. All relevant distances are known to the control unit of the system. Advantageously, in pure abrasive drilling systems, directional sensors may be located closer to the drill bit-which may facilitate a more accurate steering.

The control unit may employ simple or complex directional objectives for the drilling. The functionality of the control unit can be upgraded by applying model based process control. Preferably an algorithm is provided which derives the drill string rotational velocity and the toolface angle of the abrasive jet nozzles that the abrasive jet passes through. In an embodiment, the control loop comprises a large control loop with a directional controller, and a small control loop with a concentration modulation controller.

In the large control loop, the directional controller has as an input a directional objective. Measurements of sensors at the drill bit, including e.g. positional sensors, e.g. accelerometers in three directions, gyroscopic sensors in three directions, magnetic sensors, e.g. magnetometers, in three directions, in particular for detecting the orientation of the bit relative to the earth magnetic field, particle presence detection sensors, e.g. three, and/or geographical data are fed into a directional controller which controls based on the measurements and the directional objective the directional action, the rotation, phase, and radius of the drill bit. The directional controller furthermore stores these data in a memory, and outputs to the surface if and to what extent the directional objective is achieved. The directional controller furthermore utilizes the response of a concentration modulation controller of a small control loop as a basis for its actions.

In the small control loop, the concentration modulation controller has as its input the output of the directional controller of the large loop, and sensor measurements including temperature, flow rate, pressure, and particle presence detection, in particular in the form of quantity measurements of the abrasive particles. The concentration modulation controller controls the generation of the stream portions by the actuator. The response of the measurement devices downstream of the actuator is fed back into the controller for verification of achieving the control objective. The control actions of the controller are as mentioned above also fed back to the directional controller of the large control loop. The control actions are also stored in a memory.

The large control loop is e.g. executed in a time span in the order of multiple minutes, typically more than 10 minutes. The small control loop is typically faster than a minute.

The invention furthermore relates to a method and system for controlling the concentration and/or flow rate of the abrasive particles in the stream of drilling fluid mixed with abrasive particles in the directional drilling system based on the output signal(s) of the device(s) according to the invention, e.g. as described above in relation to the assembly according to claim 28.

The invention furthermore relates to an assembly of the described assembly with the control unit, and an electrical power source which is connectable or connected to the coil of each device via the connection points thereof for providing the electrical current through the coil, wherein the electrical power source is configured to provide the electrical current through the coil of the device as a varying, preferably an alternating, current. In an embodiment the control unit is furthermore programmed to determine a noise part of the communicated signal, or any values determined therefrom by the control unit, e.g. the amount and/or velocity of particles and/or changes therein. Such determination of the noise part involves determining a difference between respective magnitudes of the flux densities indicated by the signal, or therefrom determined values, that are measured while the electrical current through the coil is different, i.e. in case of alternating current, is oppositely directed. The noise part is determined from this difference. A clean part of the signal, or values determined from the signal, is determined by subtracting the noise part from the signal, or from the associated therefrom determined values, respectively. For example, in case of a constant disturbing magnetic field, e.g. the earth magnetic field, the disturbing magnetic field will cause a contribution to the signal which is equal in direction and magnitude irrespective of the value or direction of the current—i.e. does not vary along with the current. The noise part of the signal can then be determined by determining the constant contribution to the signal while the current is varied.

### Directional Drilling System, Steerable Sub, and Methods

The invention furthermore relates to a directional drilling system according to claim 35, and to a steerable sub according to claim 36.

The invention furthermore relates to methods according to claims 37 and 38.

### DESCRIPTION OF THE DRAWINGS

The invention will now be described with reference to the appended drawings. In the drawings:

FIG. 1 shows, schematically, a system for directional abrasive jet drilling,

FIG. 2a shows, schematically, the device in a partly exploded view,

FIG. 2b shows, schematically, the device of FIG. 2a being assembled and applied along a stream through a tube,

FIG. 3a shows in a partly exploded view, schematically, components of a device according to the invention,

FIGS. 3b-d show, schematically, the components of FIG. 3a being assembled,

FIG. 4a shows, schematically in an axial-diametrical cross-section, a tube with therethrough a stream with particles, and a coil therearound producing a magnetic field for measuring particle concentration,

FIG. 4b shows, schematically, the same tube with stream, and coil, with the device according to the invention being applied,

FIG. 4c shows, schematically, the intermediate member in isolation with magnetic field lines extending therethrough,

FIG. 4d shows, schematically, the sleeve in isolation with magnetic field lines extending therethrough, and

FIG. 4e shows, schematically, the sleeve in isolation in a diametrical-axial cross-section through the axial lip thereof.

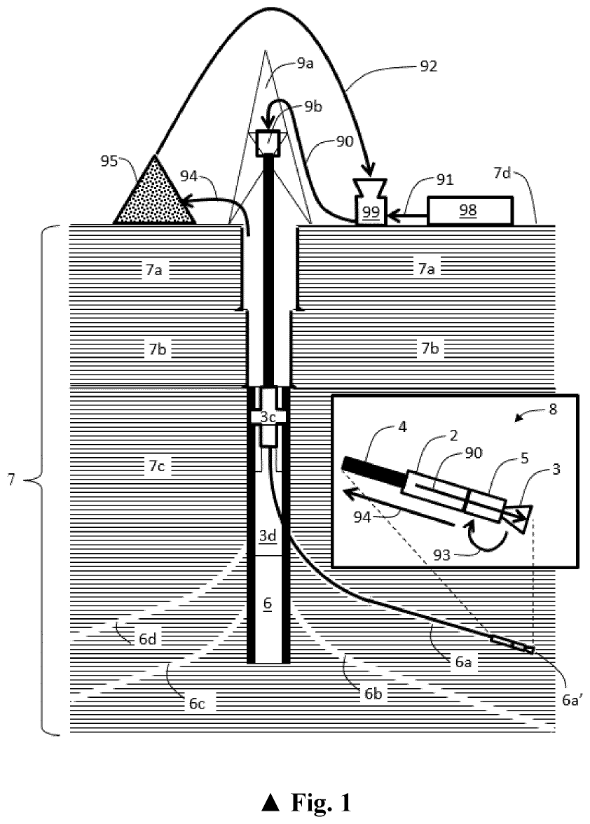

FIG. 1 illustrates a system 8 for directional abrasive jet drilling. The present invention is envisaged to be used in such a system.

The system has a sub 2 which is connected at a downhole end thereof via a recirculation sub 5 to a drill bit 3 of the system so as to be rotatable along therewith. At another end thereof the sub 2 is connected to a tubular drill string 4 of the system 8. The system 8 is shown in FIG. 1 during a method of directional drilling of a curved borehole 6a in a subterranean earth formation 2. The drilling has in the drawn situation already progressed through limestone layer 7a and sandstone layer 7b into a rock layer 7c of the subterranean earth formation.

The drill string 4 is rotated by top drive 9b of drilling tower 9a at the surface 7d. Within the cement casing of a main, vertical borehole 6, an anchor 3c is arranged and a whipstock 3d, which guides the drill string 4 through the casing to deviate into borehole 4a. Borehole 6a is the last of four curved boreholes 6a, 6b, 6c, 6d deviating from the main borehole 6 being drilled. All deviating curved boreholes 6a, 6b, 6c, 6d comprise a curved section and a subsequent straight section. The directional drilling system 8 is shown while deepening the straight section of borehole 6a. Borehole 6a has a borehole bottom 6a′.

At the surface 7d, besides the tower 9a and top drive 9b, a pump 98 is provided which pumps drilling fluid 91 through a particle injection device 99. In particle injection device 99, abrasive particles 92 from an abrasive particles supply 95 are combined with the drilling fluid 91 to form a stream 90 of the drilling fluid 91 mixed with magnetic abrasive particles 92. During an envisaged drilling operation with a constant progression of the borehole 6a, the stream 90 is with a substantially constant flow rate ϕ₉₀ and a substantially constant concentration of magnetic abrasive particles 92 supplied to the sub 2. Therein the stream 90 is passed through a, generally tubular, supply channel that runs through the drill string 4 into the system 8, inside which it runs subsequently through the steerable sub 2 and a recirculation sub 5 and drill bit 3. The drill bit 3 is in this case an abrasive jet drill bit, having a single jet nozzle which rotates with the drill bit 3, through which the stream 90 passes. After passing the jet nozzle of the drill bit 3, the stream 90 impinges the borehole bottom 6a′ in the form of an abrasive jet of said stream 90, so as to erode the borehole bottom 6a′. After this impingement, the stream 90 progresses upwardly again towards the surface 7d, moving in between the annular space in between the cylindrical borehole wall and the system 8. While passing the recirculation sub 5, a portion of the abrasive particles 92 inside the stream 90 is captured from the annulus by the recirculation sub 5, and recirculated within the recirculation sub as a recirculation stream 93 to the stream 90. After the capture of the abrasive particles 92, the stream 90 progresses further towards the surface as return stream 94. The particles 92 still left in the recirculation stream 94 are filtered at the surface 7d to join the supply 95 of abrasive particles 92.

In order to achieve differential holemaking, wherein a first azimuthal section of the borehole bottom 6a′ is eroded to a larger extent than a second azimuthal section so as to after a sustained period obtain a bend in the borehole 6a, stream portions of the stream having alternatingly high and low concentrations of abrasive particles 92 are alternatingly directed to respectively the first and second azimuthal section. These stream portions are generated by an actuator in the sub 5.

The present invention may be applied in the system 8 along the stream 90 inside the steerable sub 2, for determining the concentration and velocity of the particles 92 within the stream 90. Thereto, multiple devices 70 according to the invention are applied along the stream 90 within the steerable sub 2. The determined concentration and velocity of the particles 92 is used by a control unit 61 of the system 8 for controlling a rotation of the drill bit 3, and for controlling the actuator generating the stream portions within the stream 90 with alternatingly high and low concentrations of particles 92. The control unit 61 determines based on the velocity of the particles 92, and respective timings at which the high and low concentration stream portions pass one or more of the measurement locations, respective timings at which the respective stream portions will pass the jet nozzle of the drill bit 3. The control unit 61 then synchronizes the rotation of the drill bit 3, and therewith, of the jet nozzle, and the generation of the stream portions with each other, such that the jet nozzle is at the respective timings of passing the high and low stream portions directed towards respectively the first and second azimuthal section of the borehole 6a′. Furthermore the actuator is controlled by the control unit 61 such as to realize the concentrations necessary to achieve the desired erosive power of the abrasive jet, including the concentration difference between the stream portions required for the differential holemaking, as well as the timings and volumes at which they are generated. In WO2021069694 an example of such actuator is disclosed.

The devices 70 are in the steerable sub 2 envisaged to be arranged at multiple respective axial measurement locations—for example a first device 70 halfway between a fluid inlet of the sub 2, where the stream 90 is received from the drill string 4 and the actuator, a second and third device 70 at or near an inlet and an outlet of the actuator, and a fourth device 70 at or near a fluid outlet of the sub 2.

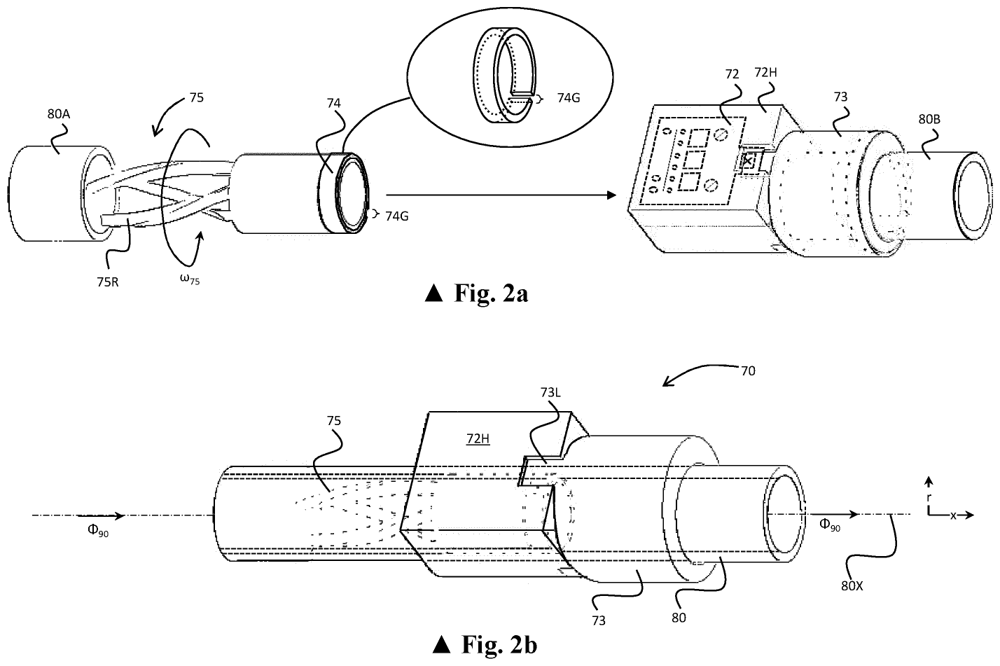

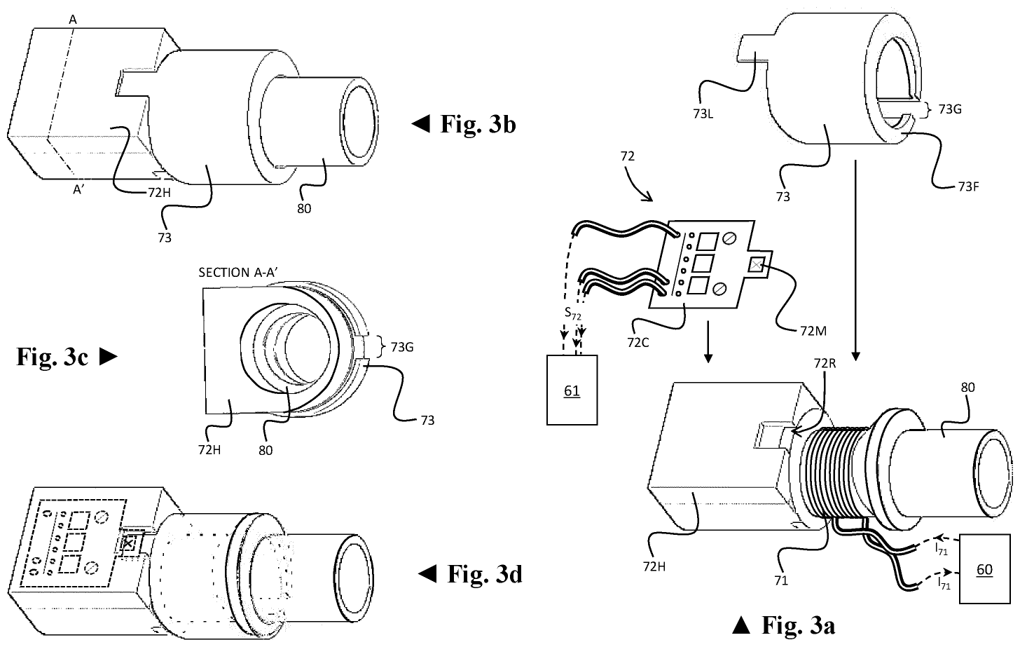

The devices 70 are provided to a tubular channel 80 of the sub 2 which interconnects the fluid inlet and fluid outlet thereof, through which the stream 90 flows with a flow rate ϕ₉₀, see FIG. 2b. The tube 80 forms a circumferential enclosure for the stream 90 and has an axial center axis 80X. In FIG. 2b the radial direction r, outwardly from and perpendicularly to the axial center axis 80X, and the axial direction x are indicated. The device 70 comprises a coil 71 inside a sleeve 73, a sensor 72 inside a sensor housing 72H which axially abuts the sleeve 73 upstream thereof, an intermediate member 74, and a whirler 75. In FIG. 2a it is shown that the tube 80 comprises an upstream part 80A and a downstream part 80B, and that the intermediate member 74 is embedded exteriorly in the wall of the upstream part 80A at the downstream axial end thereof. The whirler 75 is rotatably mounted inside the upstream part 80A upstream of the intermediate member 74, such as to enable rotation ω₇₅ of helix-shaped ribs 75R thereof. Note that the mounting of the whirler is not shown-only a center portion of the ribs 75R of the whirler 75 is drawn. The upstream part 80A of the tube 80 is axially insertable in the downstream part 80B such that a most downstream wall portion thereof axially overlaps with, and radially inwardly abuts, a most upstream wall portion of the downstream part 80B of the tube 80. When inserted as in FIG. 3b, this results in the intermediate member 74 being radially sandwiched between the wall portions so as to be effectively arranged inside the tube wall, shielded from both the stream 90 and the external environment of the tube 80.

FIG. 3a shows the upstream part 80B of the tube with the mentioned components of the device 70 that are provided to this part, the sensor 72 not yet being arranged in the housing 72H, and the sleeve 73 not yet being arranged over the coil 71, so that these components are visible in more detail. FIGS. 3b-d show the components in an installed position, including a cross-section A-A′ in FIG. 3c viewed in a downstream direction.

Firstly referring to FIG. 3a, it is visible that the coil 71 has multiple electrically conducting windings arranged to each tangentially surround the stream at the axial measurement location. The windings are wound directly around the exterior of the tube 80. The coil 71 has connection points via which the coil 71 is electrically connected to an electrical power source 60 of the abrasive jet drilling system 8, here represented simply by the wires. When the power source 60 establishes an electrical current flow 171 through the coil 71, the coil windings together generate a magnetizing field (H) which extends with a radially inwards part thereof inside the stream 90 and with a radially outwards part thereof outside the stream 90.

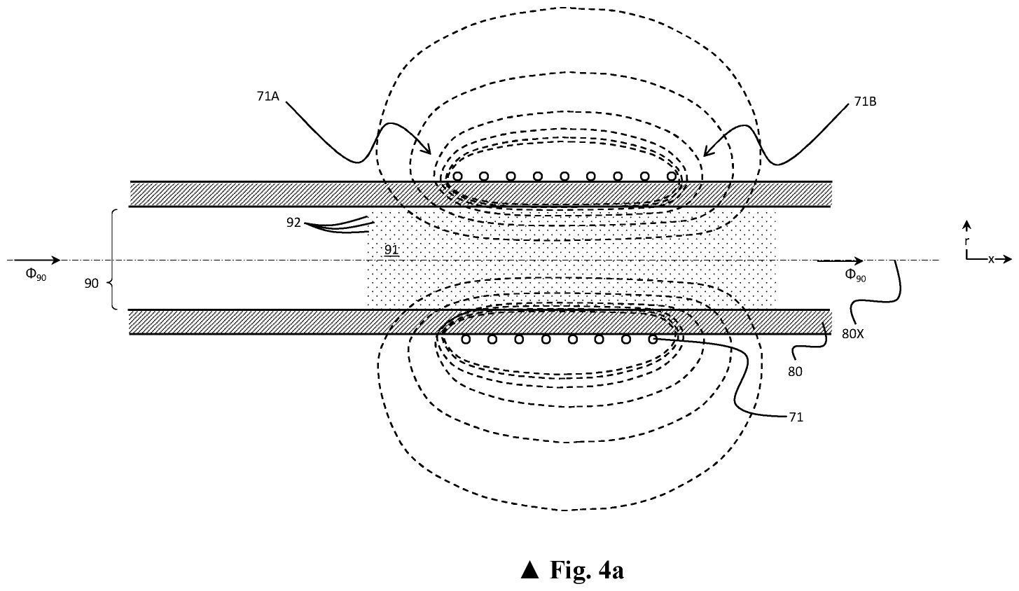

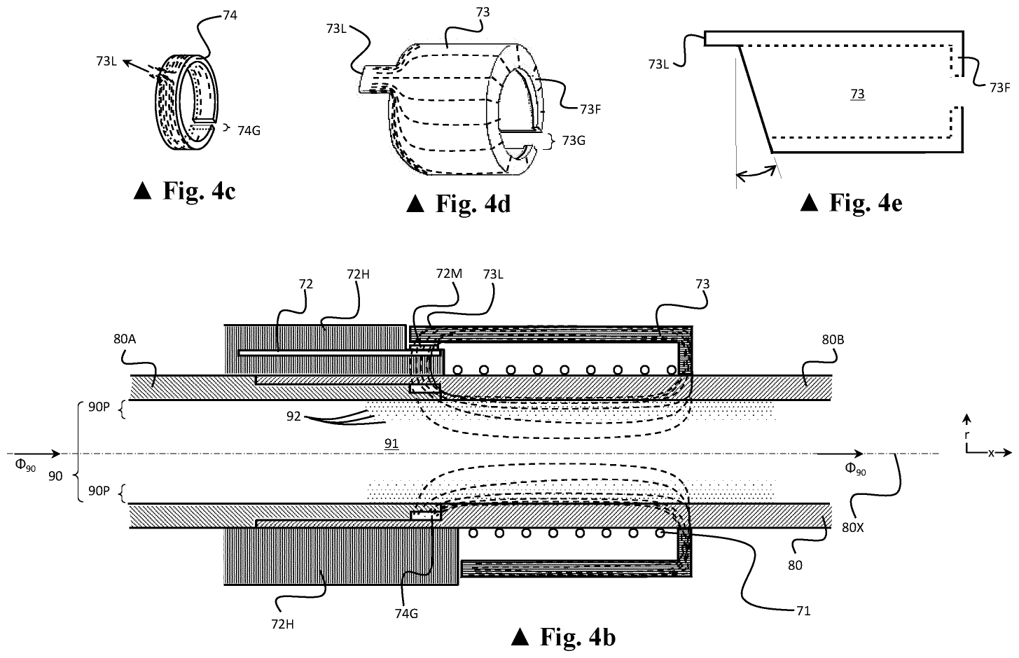

In FIG. 4a, showing an axial-diametrical cross-section through a tube 80, it is illustrated by means of field lines indicating lines of equal field strength, how such a magnetizing field H extends around the coil windings when the coil 71 of the device 70 wound around the tube 80 when the other components of the device 70 are not present, i.e. without the sensor 72, sensor housing 72H, sleeve 73, intermediate member 74, and the whirler 75. The particles 92, illustrated by dots, pass through a radially inwards part of the magnetizing field. As is known in the art the field strength decreases with distance to the coil windings. As the particles 92 are magnetically conducting, a larger concentration of particles 92 present in the stream 90 inside the magnetizing field, increases a magnetic conductivity (μ) in the radially inwards part of the magnetizing field (H), and therewith a density (B) of a magnetic flux acting back on the current 171 through the coil 71.

Referring again to FIGS. 3a-d, the sensor 72 of the shown device 70 is based on a measurement of the flux density B within the magnetizing field (H)—thus not a voltage and current measurement on the coil 71, for reasons of accuracy. The sensor 72 thereto comprises a triaxial magnetometer 72M which is mounted to a circuit board 72C of the sensor 72. The sensor 72 is configured for producing a signal S₇₂ indicative of the magnetic flux density (B) and/or a therein. Via connection points on the circuit board the sensor 72 is operatively connected to the control unit 61 of the abrasive jet drilling system 8, so that the signal S₇₂ is communicated to the control unit 61.

According to the invention, the device 70 further comprises, for increasing an electromagnetic permeability (μ) in the magnetizing field (H) and therewith, the magnetic flux density (B), a permeability promotor. The effect of the promotor is illustrated in FIG. 4b, which schematically shows an axial-diametrical cross-section through the tube 80 with the device 70 provided thereto in accordance with the arrangement of FIGS. 2-3, with the cross-section running through the axial lip 73L of the sleeve 73 and the diametrically opposite gaps 73G, 74G of the sleeve 73 and the intermediate member 74 respectively.

Firstly, the whirler 75 of the device 70 has directed the magnetic abrasive particles 92 in the stream 90 in the radially outwards direction r with respect to a center axis 80X, towards an inner circumference of the coil 71. This makes that the concentration of the particles 92 is increased in a radially outer portion 90P of the stream 90, where the field strength of the magnetizing field (H) generated by the coil 71 is higher. The result is that a change in the concentration of the particles (92) has a larger effect on the permeability (μ) of at the measurement location—and thus an increased sensitivity of the measurement of the flux density (B) for the particle concentration. As explained herein before, this may enhance the accuracy of the measurement-decreasing for instance the influence of the type of the fluid 91—and may decrease the required current through the coil 71, to the benefit of a reduced energy consumption, and/or the required size of the coil 71 to enhance the accuracy of a known axial location of the measured particles 92. The whirl is created around the center axis 80X. Thereto the connection of the helical ribs 75R to the tube 80 is such that the ribs 75R are together rotational around an axial rotation axis which coincides with the axial center axis 80X of the tube 80—the three ribs 75R being identical to one another, having a corresponding axial extension in the stream 90, and being angularly evenly distributed around the axis 80X.

Secondly, the sleeve 73 and the intermediate member 74 form magnetically conducting elements which extend in the radially outwards portion of the magnetic field (H), essentially along the original field lines, see FIGS. 4a and 4b, from an upstream axial end 71A of the coil 71 to an downstream axial end 71B. The conducting property makes that the sleeve 73 and intermediate member 74 guide the field lines of the magnetizing field (H) therethrough. Therewith the sleeve 73 and member 74 concentrate the radially outwards portion of the magnetizing field (H) therein-compare FIG. 4b with FIG. 4a. Thus the field lines are bent off relative to the situation of FIG. 4a without these elements 73,74, so as to extend through the conductive material of the sleeve 73 and intermediate member 74. The sleeve 73 and the intermediate member 74 both tangentially extend along essentially the entire coil circumference, i.e. the entire angular range with respect to the axial center axis so that the guidance and concentration takes place over the whole angular range of the magnetizing field (H). Both have a narrow gap 73G, 74G, which axially extends through each element 73, 74 thereby separating two tangential ends thereof-interrupting any tangentially directed electrical currents through the elements 73, 74 which may be disturbing e.g. to an alternating magnetizing field (H) generated through an alternating current (AC) through the coil 71.

In the shown embodiment, the magnetometer 72M is arranged near the upstream axial end of the coil, and such as to be radially aligned with, and located in between the intermediate member 74 and a lip 73L which axially protrudes from the sleeve 73. This has the advantage that the concentrated magnetizing field (H) is effectively guided through the magnetometer 72M, which may improve the quality of its measurement and therewith the signal S₇₂ produced by the sensor 72. The sleeve 73 guides the magnetizing field (H) from the magnetometer 72M via the axial lip 73L, outside the coil 71 axially via a tangentially-axially extending portion to beyond the downstream axial end of the coil 71, and radially therefrom via a radial flange 73L to the tube exterior where it snugly mates therewith, the flange 73 thereto having an inner circumference corresponding to the outer circumference of the tube 80. The intermediate member 74 conducts the magnetic field (H) between the stream 90 and the magnetometer 72M, due to its arrangement effectively inside the wall of the tube 80. Both the sleeve 73 and the intermediate member 74 are cylindrically shaped and extend concentric to the coil 71, and to one another, as can be verified. The sleeve 73 has a small distance to the coil 71 of no more than 50% of the tube diameter along its extension, see FIG. 4b. It axially abuts the sensor housing 72H at its upstream axial end, such that the coil 71 is enclosed between the tube 80, the sleeve 73, and the sensor housing 72H. The distance of the intermediate element 74 to the coil 71 is even smaller-even within 10% of the tube diameter.

The advantageous arrangement of the magnetometer 72M between the conducting elements 73, 74 is facilitated by the sensor housing 72H. In particular, by the fact that the axial lip 73L is received, in the upstream direction, in the axial recess 72R of the housing 72H, and that the sensor 72 is shaped and accommodated in the housing 72H such that the magnetometer 72M also extends in the axial recess 72R, radially inwards from the axial lip 73L. Thereto the magnetometer 72M is mounted on an axially protruding lip of the circuit board 72C at the downstream end thereof, the rest of the circuit board 72C extending inside the housing 72H at the upstream side of the recess 72R, such that the lip protrudes inside the recess 72R in the downstream direction.

In FIG. 4b, it is illustrated, again schematically, how a number of field lines of the magnetic field (H) may run as a result of the device 70 in operation, in order to elucidate the working principle thereof. At the downstream axial end of the coil 71, the field lines are guided, axially downstream of the coil 71, radially outwardly by the flange 73L of the sleeve 73 from the outer circumference of the tube 80 to radially beyond the coil windings, and from there axially towards the upstream axial end 71A. The sleeve 73 concentrates the field lines radially within the thickness of the sleeve 73—compare FIGS. 4a and 4b. At the upstream axial end 71A, the field lines are furthermore angularly concentrated within the axial lip 73L, so that these substantially extend within the angular range of the axial lip 73L with respect to the center axis 80X. The extension of the field lines through the sleeve 73 is further illustrated in FIG. 4d, showing the sleeve 73 in isolation.

The radially and angularly concentrated field lines are urged from the axial lip 73L to the intermediate member 74 in the radially inwards direction, facilitated by the radial alignment thereof with the axial lip 73L. This causes the field lines to be guided and concentrated through the magnetometer 72M. The field lines received by the intermediate member extend tangentially through the intermediate member, bending off along the angular range radially inwardly to the radially inwards portion of the magnetic field (H) within the stream 90, in particular in the radially outwards part 90P of the stream 90 in which the magnetic particles 92 are concentrated. The extension of the field lines through the intermediate member 74 is further illustrated in FIG. 4c, showing the intermediate member 74 in isolation.

In FIG. 4e, the sleeve 73 is shown once more, viewed in a radial direction with the axial lip 73L on the top side left. It is visible in this view that at the axial end of the sleeve 73 where the axial lip 73 is provided, i.e. the upstream axial end in the configuration of FIG. 4b, the sleeve 73 is tapered so that an axially outer edge of the sleeve 73 extends from the lip 73L to the diametrically opposite side of the sleeve 73, i.e. the bottom side, slanting in the axial direction away from the lip 73L. The so created angle with the radial direction through the lip 73L is indicated.

The slanting of the upstream end of the sleeve 73 has, in the configuration of FIG. 4b, the result that along an angular range of the intermediate member 74 outside the angular range of the axial lip 73L of the sleeve 73, a shortest distance between the sleeve 73 and the intermediate member 74 is larger than a shortest distance between the axial lip 73L and the intermediate member 74 within the angular range of the axial lip 73L of the sleeve 73. This can be verified at the bottom side, diametrically opposite to the axial lip 73L: the sleeve 73 extends more downstream from the intermediate member 74, and therefore has a larger distance thereto, than at the top side of the axial lip 73L where it is radially aligned with the sleeve 73, namely with the axial lip 73L thereof. This essentially enhances the effect of the axial protrusion of the axial lip 73L from the upstream sleeve edge, namely the guidance of the magnetic field lines in the radially outwards portion of the magnetic field (H) that extend outside the angular range of the magnetometer 72M towards the axial lip 73L of the sleeve 73, and thus towards radial alignment with the magnetometer 72M, through the sleeve 73 itself, having a tangential component, and subsequently, within this angular range, through the magnetometer 72M from the axial lip 73L to the intermediate member 74. Such extension of the field lines is depicted in FIGS. 4b-d. Thus the tendency for these magnetic field lines to run tangentially towards the axial lip 73L through the intermediate member 74 so as to unduly bypass the magnetometer 72M is decreased.

1. A device for measuring, in a stream of fluid mixed with magnetic particles flowing through an elongate circumferential enclosure and having an axial flow direction, a concentration of the magnetic particles at an axial measurement location along the stream, wherein the circumferential enclosure, and therewith, the stream, has an axial center axis,
wherein the device comprises:
a coil with multiple electrically conducting windings, arranged to each tangentially surround the stream at the axial measurement location, and to together generate, when an electrical current flows through the windings of the coil, a magnetizing field having
a radially inwards part of the magnetizing field within the radial extension of the stream, of which field lines extend inside the stream and axially through the coil, and,
a radially outwards part of the magnetizing field outside a radial extension of the stream, of which field lines extend outside the stream and surround the axial extension of the coil, the coil having connection points for electrical connection to an external electrical current source,
a sensor configured and arranged for producing a signal indicative of a magnetic flux density caused by the magnetizing field generated through and outside the coil and/or a change in this magnetic flux density, the sensor having connection points for connection to an external control unit,
wherein the device further comprises, for increasing an electromagnetic permeability in the magnetizing field and therewith, the magnetic flux density,
a permeability promotor, which comprises:
a particle directing tool configured for directing the particles in the stream with respect to the center axis, in a radially outwards direction towards an inner circumference of the coil, such that within the radial and axial extension of the coil a particle concentration is higher in a radially outwards part of the stream relative to a radially inwards part of the stream, and/or
in the radially outwards part of the magnetizing field, one or more magnetically conducting elements spaced from the coil by at most approximately half the diameter of the stream and extending so as to guide therethrough the field lines of the magnetizing field in their extension within the radially outwards part of the magnetizing field and concentrate these field lines in a plane transverse to the field lines.

2. The device according to claim 1, wherein the particle directing tool, if present, of the permeability promotor is configured for being arranged inside the circumferential enclosure at, and/or upstream of, the axial measurement location, wherein the particle directing tool comprises one or more directing elements configured for directing the particles within the stream radially outwardly, and a mounting element for connection of the directing elements to the circumferential enclosure.

3. The device according to claim 2,
wherein the particle directing tool is a whirler, configured to generate in the stream a whirl in a radially central portion of the circumferential enclosure wherein the connection of the directing elements of the particle directing tool to the circumferential enclosure via the mounting element is such that the directing elements are rotational around an axial rotation axis.

4. The device according to claim 3,
wherein the one or more directing elements are one or more ribs, each helically shaped around the axial rotation axis of the whirler.

5. The device according to claim 1,
wherein the particle directing tool is provided within the axial extension of the coil, and/or upstream of the coil.

6. The device according to claim 1,
wherein one or more of the magnetically conducting elements, if present, of the permeability promotor tangentially extend along the majority of the coil circumference, i.e. over the majority of, the angular range with respect to the axial center axis.

7. The device according to claim 1,
wherein one or more of the magnetically conducting elements, where present, are arranged and dimensioned to extend at a distance from the coil of around 50% of a diameter of the coil or smaller.

8. The device according to claim 1,
wherein one or more of the magnetically conducting elements, where present, are configured to conduct in at least the axial direction.

9. The device according to claim 1,
wherein the magnetically conducting elements, where present, of the permeability promotor comprise a magnetically conducting sleeve, configured to tangentially surround the coil at least between axial ends thereof, for axially conducting the generated magnetizing field at least between these axial ends, wherein the sleeve axially extends along a major part of the coil.

10. The device according to claim 9,
wherein the sleeve is cylindrically shaped and/or configured to, viewed in the axial direction, extend concentric to the coil.

11. The device according to claim 9,
wherein the sleeve is configured to, axially beyond the coil, e.g. at both axial ends, mate with the circumferential enclosure.

12. The device according to claim 11, wherein the coil is adapted to surround the circumferential enclosure, and the sleeve has between axial ends thereof an inner circumference which is radially spaced from the coil, the sleeve extending at one or both of the axial ends thereof axially beyond the coil, and furthermore has at these one or both of the axial ends a radially inwards flange adapted to mate with the circumferential enclosure.

13. The device according to claim 9, wherein the sleeve has a gap which axially extends through the sleeve thereby separating two tangential ends of the sleeve and interrupting any tangentially directed electrical currents through the sleeve.

14. The device according to claim 1,
wherein the magnetic sensor comprises a magnetometer arranged inside the magnetizing field generated through and around the coil.

15. The device according to claim 14,
wherein the magnetometer of the sensor is arranged at or near an axial end of the coil, and the sleeve comprises an axial lip which projects from the sleeve such as to radially align with the magnetometer.

16. The device according to claim 14,
wherein the magnetically conducting elements of the permeability promotor comprise a magnetically conducting intermediate member, arranged to extend within the generated magnetizing field at least partly between the magnetometer and the stream, for conducting the generated magnetizing field between the stream and the magnetometer.

17. The device according to claim 16,
wherein the intermediate member is cylindrically shaped and/or configured to, viewed in the axial direction, extend concentric to the coil.

18. The device according to claim 16,
wherein the intermediate member is configured to surround the stream,
the intermediate member being adapted to mate with the circumferential enclosure.

19. The device according to claim 16,
wherein the intermediate member has a gap which axially extends through the intermediate member thereby separating two tangential ends of the intermediate member and interrupting any tangentially directed electrical currents through the intermediate member.

20. The device according to 15, wherein the magnetometer extends between the axial lip of the sleeve and the intermediate member.

21. The device according to claim 14,
further comprising a sensor housing configured to with an axial end thereof axially abut the sleeve, wherein the sensor housing has at the abutting axial end an axial recess configured to receive the axial lip, and is configured to accommodate the sensor therein, with the magnetometer extending inside the recess as well to establish the radial alignment with the axial lip, wherein the magnetometer extends radially inwards of the axial lip.

22. The device according to claim 1,
wherein the coil is adapted to surround the circumferential enclosure.

23. An assembly of one or more devices according to claim 1 and the elongate circumferential enclosure for accommodating the stream therethrough, wherein the circumferential enclosure is made out of a magnetically and electrically non-conducting material.

24. An assembly according to claim 23,
wherein each device is embodied according to claim 21, wherein the coil of each device is wound around the circumferential enclosure.

25. An assembly according to claim 23,
wherein each device is embodied according to at least claim 16, wherein the circumferential enclosure comprises a first, upstream axial part thereof and a second, downstream axial part thereof, wherein one of the axial parts is axially insertable into the other one of the axial parts with the intermediate member radially in between axially overlapping wall portions of the two axial parts.

26. An assembly according claim 23,
comprising multiple devices according to claim 1, wherein the devices are arranged such that the axial measurement locations of the devices are at an axial distance from one another.

27. An assembly of one or more devices according to claim 1,
and an electrical power source connectable or connected to the coil of each device via the connection points thereof for providing the electrical current through the coil.

28. An assembly according to claim 27,
wherein the electrical power source is configured to provide the electrical current through the coil of the device as an alternating current.

29. An assembly of one or more devices according to claim 1, and a control unit which is connectable or connected to the sensor of each device via the connection points thereof for communication of the signal produced by the sensor to the control unit, wherein the control unit is programmed to determine from the communicated signal produced by the sensor, indicative of the magnetic flux density, an amount of the magnetic particles within the stream passing the axial measurement location.

30. An assembly according to claim 29,
comprising multiple devices according to claim 1, wherein the axial measurement locations of the devices are at an axial distance from one another,
and wherein the control unit is furthermore programmed to determine a velocity of the particles passing the axial measurement locations, based on the axial distance between the respective measurement locations of the devices, and a time period between the passing of these measurement locations by the particles.

31. An assembly according to claim 30,
wherein the control unit is furthermore programmed to predict a timing at which the passed particles will arrive at an axial location downstream of the measurement locations, based on the determined amount and velocity of these particles.

32. An assembly according to claim 31 for use in a directional drilling system,
wherein the particles are abrasive particles, and the downstream location is a location of one or more abrasive jet nozzles configured for ejecting the stream in the form of an abrasive jet into impingement with a borehole bottom at different azimuthal positions as controlled by the control unit,
and wherein the control unit is furthermore programmed to in dependence of the determined amount of the particles passing the measurement location, at the predicted timing of their arrival at the jet nozzles, selectively cause ejection of these particles at a determined one of the azimuthal positions.

33. An assembly according to claim 29 for use in a directional drilling system,
wherein the control unit is furthermore connected to an actuator of the drilling system for producing, in the stream supplied to the jet nozzles, stream portions with varying, e.g. alternatingly high and low, concentrations of particles, and is furthermore programmed to in dependence of the determined amount of the particles passing the measurement location and/or a determined velocity of the particles and/or a predicted timing of arrival thereof at the jet nozzles, control the actuator such as to adjust one or more properties of these stream portions.

34. An assembly of an assembly according to claim 29 and an electrical power source connectable or connected to the coil of each device via the connection points thereof for providing the electrical current through the coil, wherein the electrical power source is configured to provide the electrical current through the coil of the device as an alternating current.

35. An assembly according to claim 34,
wherein the control unit is furthermore programmed to determine a noise part of the communicated signal, or any values determined therefrom,
wherein the determination of the noise part involves determining a difference between respective magnitudes of flux densities indicated by the signal, or therefrom determined values, with oppositely directed electrical currents through the coil, wherein the noise part is determined from this difference, and wherein a clean part of the signal, or therefrom determined values, is determined by subtracting the noise part from the signal, or therefrom determined values, respectively.

35. (canceled)

36. A steerable sub for use in a directional drilling system,
the sub being connectable at a downhole end thereof to a drill bit, and at another end thereof to a tubular drill string, the sub comprising:
a sub fluid inlet port, fluidly connectable to a supply channel through the drill string to receive from said supply channel the stream of drilling fluid mixed with abrasive particles when the system is connected to the drill string, and
a sub fluid outlet port, fluidly connectable to a bit fluid inlet port of the drill bit,
the sub further comprising the assembly according to claim 23, wherein the circumferential enclosure is formed by a channel of the sub which fluidly interconnects the sub fluid inlet port and the sub fluid outlet port for accommodating the stream therethrough.

37. (canceled)

38. (canceled)
